(19) United States
(12) Patent Application Publication
(10) Pub. No.: US 2005/0021683 A1
(43) Pub. Date: Jan. 27, 2005

(54) Method and apparatus for correlating network activity through visualizing network data

(76) Inventors: Chris Newton, Douglas (CA); Chris Carton, Fredericton (CA)

Correspondence Address: James C. Scheller, Jr.;BLAKELY, SOKOLOFF, TAYLOR & ZAFMAN LLP, Seventh Floor, 12400 Wilshire Boulevard, Los Angeles, CA, 90025-1026, US

(21) Appl. No.: 10/401,380

(22) Filed: Mar. 27, 2003

(51) Int. Cl. G06F 15/177

(52) U.S. Cl. 709/220

(57) ABSTRACT

Correlating network activity through visualizing network data and with identifying entities associated with targeted activities and correlating therewith other activities from those entities. Network traffic is classified into a number of conceptual views of network traffic, each instantiating view objects that are a representation of network traffic that satisfies a set of conditions. Configuration files define a hierarchy, the structure of the hierarchy, and its makeup. Any point on the hierarchy can be accessed using its Graphical Request Language (GRL) designation. Further GRL designations are used to label views associated with a point. A plurality of view objects are linked to corresponding view object databases. Define new view objects using one or more GRL does correlation and combining using logical operators. Generate a new list of addresses from the GRL address lists and place all current and subsequent traffic for those machines in the new view object.

### RELATED APPLICATIONS

The present invention relates co-pending U.S. patent application Ser. No. 09/872,995 the entire specification of which is hereby incorporated by reference.

### FIELD OF THE INVENTION

The present invention relates to method and apparatus for correlating network activity through visualizing network data and is particularly concerned with identifying sources of targeted activities.

### BACKGROUND OF THE INVENTION

The rapid development of the Internet, World Wide Web and E-commerce has made it increasingly important to be able to monitor the traffic going into and coming out of a network in order to discover abnormal network traffic that may be an indication of attacks from hackers or misuse of network resources by users inside the network. A network of computers may be attacked by a hacker using Smurf, Denial of Services (DoS), or be abused by a rogue employee within the network, who may attack some other networks or download pornography.

Various network security software, such as firewalls, Intrusion Detection Systems (IDS), network monitors, and vulnerability assessment tools, have been developed to protect a network from abuse and hacking.

Firewalls are now a mature technology. Firewalls selectively block certain types of network traffic from going into or coming out of a protected network. However, they must allow some types of network traffic to go through in order to facilitate desired network communications, such as accessing websites and transporting e-mails. Although firewalls are a mature technology, it is well known that they are far from failsafe. File Transfer Protocol (FTP) service uses port number 21. To facilitate FTP service a firewall allows such traffic to go through. A hacker thus can focus on attacks using this port number, and firewalls cannot stop the hackers using the FTP service for illegal or improper purposes. Network traffic can talk on more than 65,000 ports. A large percentage of firewalls are misconfigured so that they inadvertently let in traffic that is supposed to be blocked.

IDS systems are used to spot, alert, and stop intrusions. Typically running on dedicated computers hooked to the network, IDS systems actively monitor network traffic for suspicious activities. Statistics or rule-based artificial intelligence is used to detect abnormal activities. Thus, IDS systems depend on the recognition of known attack patterns. For example, contents in the network traffic may be monitored to match the patterns in an IDS system's databases. The real-time analysis of the network traffic provides the capability to send instant notifications via e-mails, pager alerts, or other means. Based on a predefined security policy, some IDS systems can take defensive actions against intrusions, such as initiating the termination of network connections or changing the configuration of network devices (e.g., firewalls and routers). Since hacking activities and misuse of new patterns are under constant development, IDS systems are also under constant development. IDS systems have a number of weaknesses. IDS systems depend on the recognition of known attack patterns, sequences, or signatures. Currently known signatures of attacks are collected to write rules to detect and disable network activities with these signatures. However, IDS systems cannot detect or stop the attacks of unknown signatures. IDS systems have to be upgraded when the rules are updated to handle attacks of signatures that are only recently recognized.

Sniffers are network monitors. A sniffer captures and decodes the network traffic traversing a transmission medium. Typically, when network administrators are alerted of system problems by users, or intrusions by IDS systems, or other events (e.g., a server goes down), they use a sniffer to monitor the network traffic after reviewing audit logs. The sniffer “dives” into the network traffic data to see all the detailed information. Extremely detailed information about what is transmitted in the network is shown. However, the information provided by a sniffer is so voluminous that it is technically challenging, as well as time consuming, to analyze the data provided by a sniffer.

Network administrators are frustrated by the absence of software programs, which let them see at a glance how their network is used, or abused, and who is responsible for a specific activity. Therefore, it is desirable to have a powerful tool to help administrators to organize the information about network traffic so that they can easily explore the information in an intuitive and efficient way in order to detect intrusion and misuse.

### SUMMARY OF THE INVENTION

An object of the present invention is to provide an improved method and apparatus for correlating network activity through visualizing network data.

Methods and apparatuses for method and apparatus are provided for correlating network activity through visualizing network data and with identifying entities associated with targeted activities and correlating therewith other activities from those entities.

The network traffic being monitored is classified into a number of views of network traffic. A view of network traffic is a representation of network traffic that satisfies a set of conditions. A view is directly defined by a set of conditions it must satisfy, conditions that are provided in corresponding configuration files. For example views include geographic, applications, ports, protocol, flow type, flags, remotenet, remote services.

Conveniently, each view instantiates a plurality of view objects that are linked to corresponding view object databases. For geographic view, examples of view objects are Canada, USA, Europe, Asia, Africa. Within each database, data is stored in a plurality of layers. Layers are bytes, packets, host counts, unique ports.

Accordingly, a method and apparatus are provided for correlating network activity through visualizing network data by identifying entities associated with targeted activities, correlating therewith other activities from those entities and viewing all data related to those entities.

In an aspect of the invention, there is provided a method of correlating network activity through visualizing network data, said method comprising: classifying network traffic in dependence upon first and second parameters into first and second network traffic views, respectively; creating first and second view objects corresponding to the first and second network traffic views; logically combining the first and second view objects to provide a new view object; creating a new view corresponding to the new view object; establishing a list of entities for the new view object; and associating data flows for each of the entities with the new view.

In an embodiment of the present invention the step of establishing a list of entities uses a tracking template that defines flow data fields being stored on the list.

In a further embodiment of the present invention the step of associating includes using a tracking filter that selects a subset of the data fields defined by the tracking template.

In accordance with a further aspect of the present invention there is provided a method of correlating network activity through visualizing network data, said method comprising: defining a network hierarchy having a plurality of points, each point representing at least one of physical, logical and functional components of a network; defining conceptual views of network traffic and associating the conceptual views with each point of the network hierarchy; defining view objects in each view; establishing a graphical request language designation (GRL) for each conceptual view; extending the graphical request language designation to each view object depending from each conceptual view; selecting a view and view objects that define a network behaviour subset; obtaining a list of addresses that are performing the network behaviour subset; defining new view objects using one or more GRL by combining the new view objects with logical operators; generating a new list of addresses from the GRL address lists that satisfy the logical operator functions; and placing all current and subsequent traffic for machines listed in the new list in the new view object.

In accordance with a further aspect of the present invention there is provided Machine readable media containing executable computer program instructions, which when executed by a digital processing system, performs a method comprising: classifying network traffic in dependence upon first and second parameters into first and second network traffic views, respectively; creating first and second view objects corresponding to the first and second network traffic views; logically combining the first and second view objects to provide a new view object; creating a new view corresponding to the new view object; establishing a list of entities for the new view object; and associating data flows for each of the entities with the new view.

In accordance with another aspect of the present invention there is provided apparatus for correlating network activity through visualizing network data comprising: a module for classifying network traffic in dependence upon first and second parameters into first and second network traffic views, respectively; a module for creating first and second view objects corresponding to the first and second network traffic views; a module for logically combining the first and second view objects to provide a new view object; a module for creating a new view corresponding to the new view object; a module for establishing a list of entities for the new view object; and a module for associating data flows for each of the entities with the new view.

In accordance with another aspect of the present invention there is provided a method of correlating network activity through visualizing network data, said method comprising: receiving flow information from a flow generator creating audit records about network traffic; receiving a record of information from an external device indicating a reason of notification; associating a unique identifier listed in the external record with a corresponding flow record; tagging flows so associated; classifying tagged flows into a network traffic view; and creating view objects in the view corresponding to flow values.

### BRIEF DESCRIPTION OF THE DRAWINGS

The present invention will be further understood from the following detailed description with reference to the drawings in which:

FIG. 1 illustrates in a block diagram an apparatus for correlating network activity through visualizing network data in accordance with an embodiment of the present invention;

FIG. 2 graphically illustrates a hierarchy, physical representation and hierarchy, logical representation of a network;

FIG. 3 illustrates in a functional block diagram a portion of the apparatus of FIG. 1 in further detail;

FIG. 4 illustrates in a functional block diagram, a method of correlating network activity through visualizing network data in accordance with an embodiment of the present invention referred to herein as internal correlation;

FIG. 5 illustrates in a functional block diagram a method of correlating network activity through visualizing network data in accordance with a second embodiment of the present invention referred to herein as internal correlation;

FIG. 6 illustrates in a functional block diagram the method of FIGS. 4 and 5 in greater detail; and

FIG. 7 illustrates in a block diagram a further embodiment of the present invention.

### DETAILED DESCRIPTION OF THE PREFERRED EMBODIMENT

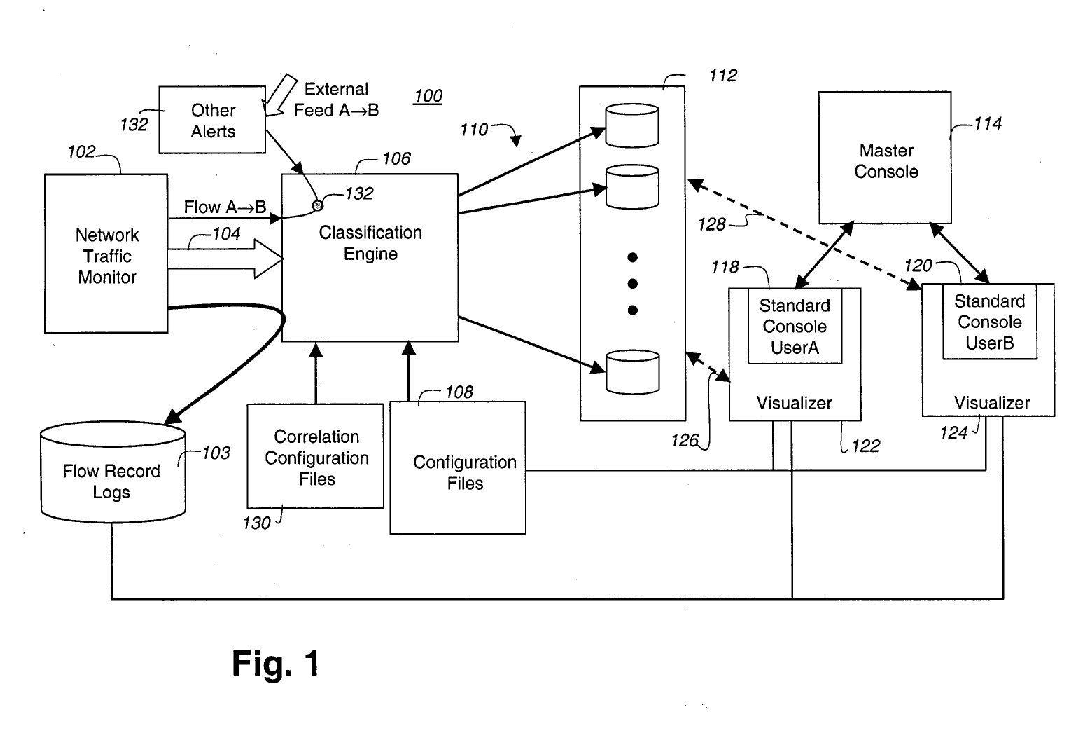

Referring to FIG. 1 there is illustrated in a block diagram an apparatus for correlating network data targeted events for providing a visual representation of a network in accordance with an embodiment of the present invention. The traffic visualization apparatus 100 includes a network traffic monitor 102 that is coupled to a portion of the network (not shown), a flow record logs storage 103, and that provides flow records 104 to a classification engine 106. The classification engine 106 uses base configuration files 108 to classify the flow records into a number of different views, each having activity records 110, stored in corresponding databases 112. A master console 114 is coupled to a plurality of standard consoles, for example userA 118 and userB 120 having visualizers 122 and 124, respectively, each visualizer communicates with the databases 112 to render a graphical representation of the network activity for each view.

The classification engine 106 also uses correlation configuration files 130 to identify special views referred to herein as internal correlation views, which have two types signature and behaviour, and other alerts 132, for example IDS alerts to identify events referred to herein as external correlation views. The flow records for the correlation views, each have activity records 110, stored in corresponding databases 112, just as for base views, however the flow record logs are tagged to associate them with the correlation view as will be explained in further detail herein below. The configuration files define the views of the network that can be visualized.

Views are ways of looking at network traffic. Whether you look at it geographically, or by protocol, there is the same amount of total traffic in both cases. However, the distribution of the traffic within the view will be different in both cases because the view objects are different in both cases. In geographic view, the view objects are continents and country names. In protocol view, the view objects are names of Internet protocol (IP) standards. Yet when one adds up all the traffic from all the countries, or adds up all the traffic from all of the protocols, the total traffic is the same. Layers are different ways of counting the traffic for each view object, for example bytes, packets, hosts, unique TCP ports. All of this is applied to a network hierarchy, such that each view and each view object is available at each point in the hierarchy.

This means that there is a database for each view→view object at each point in the hierarchy, with a parent-child relationship. That is, data stored in a parent database is equal to the sum of data stored in databases of its children. Graphical Request Language (GRL) designations are the language strings that define what views you are on, what view objects are selected, which view objects are removed, where you are in the hierarchy, and what layer you wish so see/work with. Each GRL is unique and maps directly to a set of on disk databases that store the data from the layers; this is a one-to-one relationship. Hence, two different GRLs cannot point to exactly the same data representation.

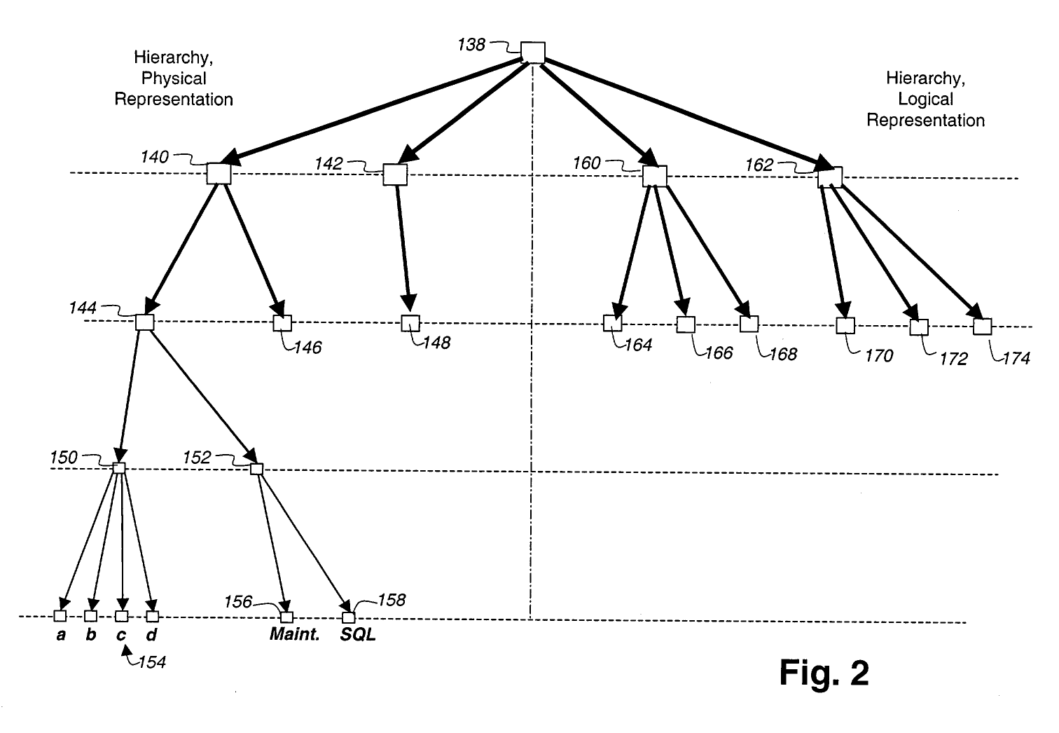

Referring to FIG. 2, there is graphically illustrated a hierarchy representing physical and logical views of a network. The network 138 includes two subnets 140 and 142. The subnet 140 includes a server farm 144 and a node 146, while subnet 142 include a node 148 (for simplicity of the illustration only one branch is expanded at lower levels in the hierarchy).

The server farm 144 includes web servers 150 and database servers 152. The web servers 150 include web servers (a, b c and d) 154. The database servers 152 include a maintenance database 156 and an SQL database 158.

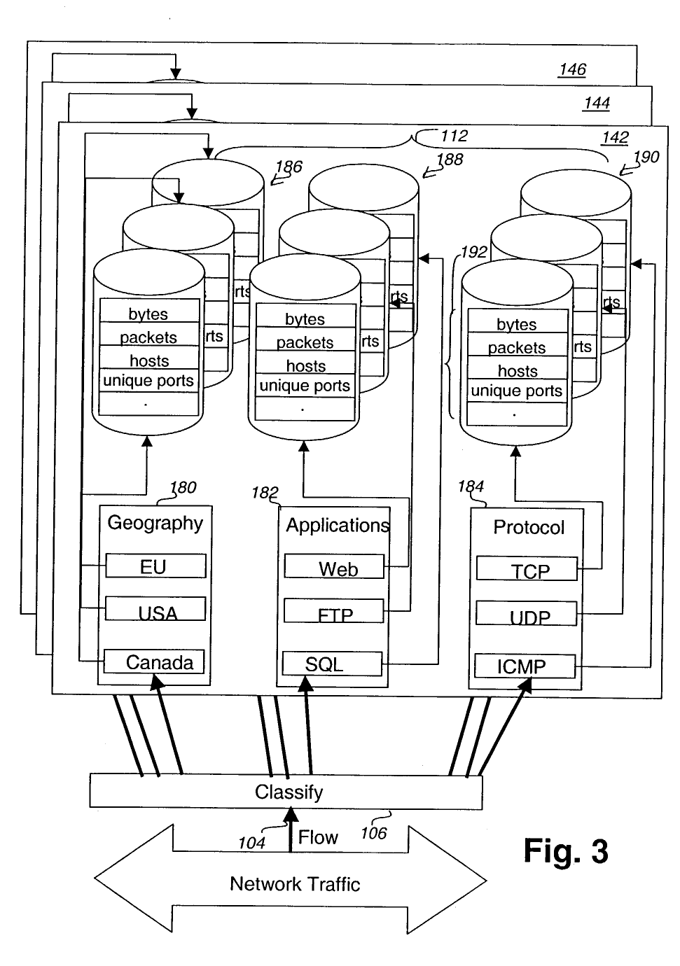

The configuration files define a hierarchy, the structure of the hierarchy, and its makeup, i.e. physical, logical, functional, or any combination thereof. Any point on the hierarchy can be accessed using its Graphical Request Language (GRL) designation. Once at a particular point further GRL designations are used to label views associated with that point. Thus on the hierarchy of FIG. 2, network traffic associated with professionals 160 and support staff 162 are designated with separate GRLs, for example, /net/prof and /net/ss, respectively. The professionals may be further subdivided into executives 164 (/net/prof/ex), managers 166 (/net/prof/mg) and non-managers 168 (/net/prof/nm). The support staff may also be subdivided into, for example, executive assistants 170 (/net/ss/ea), administrative assistants 172 (/net/ss/aa) and clerical support 174 (/net/ss/cs). GRLs are also used to designate the various views available at each point on the hierarchy, thus geographic, application and protocol views, for example at managers 166 may have the GRL designations /net/prof/mg→geo view, /net/prof/mg→apps view, and /net/prof/mg→prot view, respectively. Further details of GRL parameters are described with regard to FIG. 3.

Referring to FIG. 3 there is illustrated in a functional block diagram a portion of the apparatus of FIG. 1 in further detail. The classifier 106 uses the config files 108 to define views, for example a geographic view 180, an applications view 182, and a protocol view 184. Each view has view objects identified by a view object names, for example the geographic view 180 has view objects named Europe, Canada, USA. Similarly, the applications view 182 has view objects named web, FTP, SQL and the protocol view 184 has view objects named TCP, UDP, ICMP.

Each view object is linked to a corresponding database, the view objects of geographic view 180 are linked to the view object databases 186, the view objects of applications view 182 are linked to the view object databases 188. the view objects of protocol view 184 are linked to the view object databases 190. Within each database, data are stored in a plurality of layers, for example the layers are bytes, packets, host counts, unique ports.

At each level in the hierarchy of FIG. 2, views, view objects and their on disk representation view object databases are instantiated, for example at 142, 144, and 146. For simplicity of FIG. 3, only three points on the hierarchy are illustrated.

Graphical Request Language (GRL) parameters are used to specify what view object is selected in a particular view at a particular point in the hierarchy of FIG. 2. For example, /net/prof/mg→apps views→ftp, specifies the view object named FTP of applications view 182 at point 166 in the hierarchy of FIG. 2, and linking the corresponding database 188. As data are stored in the databases in layers (bytes, packets, hosts count, unique ports), a further GRL parameter can be used to access layers. Hence, the number of bytes of FTP traffic at point 166, is viewed by specifying: /net/prof/mg→apps view→ftp→bytes.

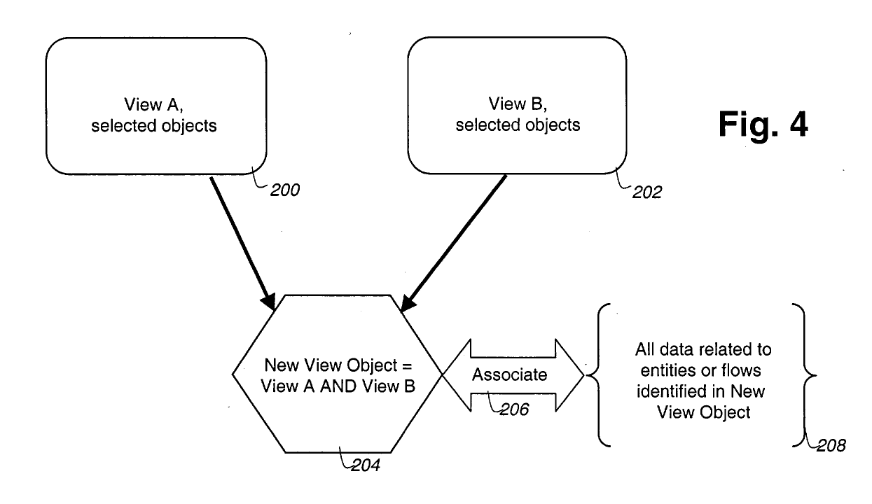

Referring to FIG. 4, there is illustrated in a functional block diagram, a method of correlating network activity through visualizing network data in accordance with an embodiment of the present invention. If we wanted all of the network data activity associated with any support staff using SQL and any traffic from Asia the following steps would be taken. A graphical representation A (200) for the staff traffic using SQL is selected by its GRL (e.g., net/ss→app view→sql), which we name GRL A1. A graphical representation B (202) for a traffic to or from Asia is selected by its GRL (e.g., net→geo view→asia), which we name GRL B. A new view is created to hold new view objects. A new view object C 204 is defined as the intersection of GRL A and GRL B (e.g., GRL A AND GRL B). Hence, new view object C 204 would include any traffic for any staff using SQL who had also been communicating with remotes IP addresses in Asia. Once this intersection is determined, the IP addresses of the identities identified are used to associate 206 those found by the intersection with all of the data related to those entities are represented by 208. This is a simple example of behaviour based internal correlation, which is the correlation of network traffic related to entities using information internal to the system itself (e.g. configuration files).

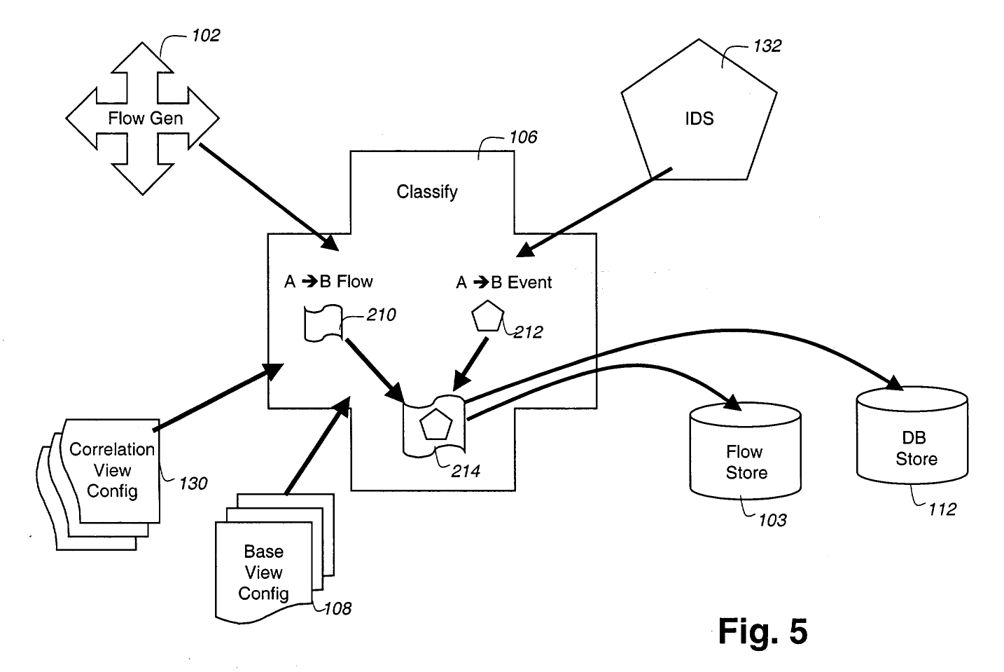

Referring to FIG. 5 there is illustrated in a functional block diagram a method of correlating network activity through visualizing network data in accordance with a second embodiment of the present invention. The method of FIG. 5 begins with the flow generator 102 providing flow records for data from A to B as represented by 210. The intrusion detection system 132 (or any other device capable of providing externally generated alerts) provides an event alert for A to B as represented by 212. Subsequent to this the classifier 106 watches all traffic between these two even in the absence of any further alerts from external sources. A correlation view config file 130 tells the classifier 106 to link the two separate occurrences, as represented by 214, by tagging all data to correlate that data with the entity responsible for the IDS alert. This is a simple example of external correlation, which is the correlation of entities using information external to the system itself (e.g. IDS alerts). Note that while external and internal correlation have been described separately for simplicity and clarity, external and internal correlation can be mixed, e.g. you could couple IDS traffic to geographic placement.

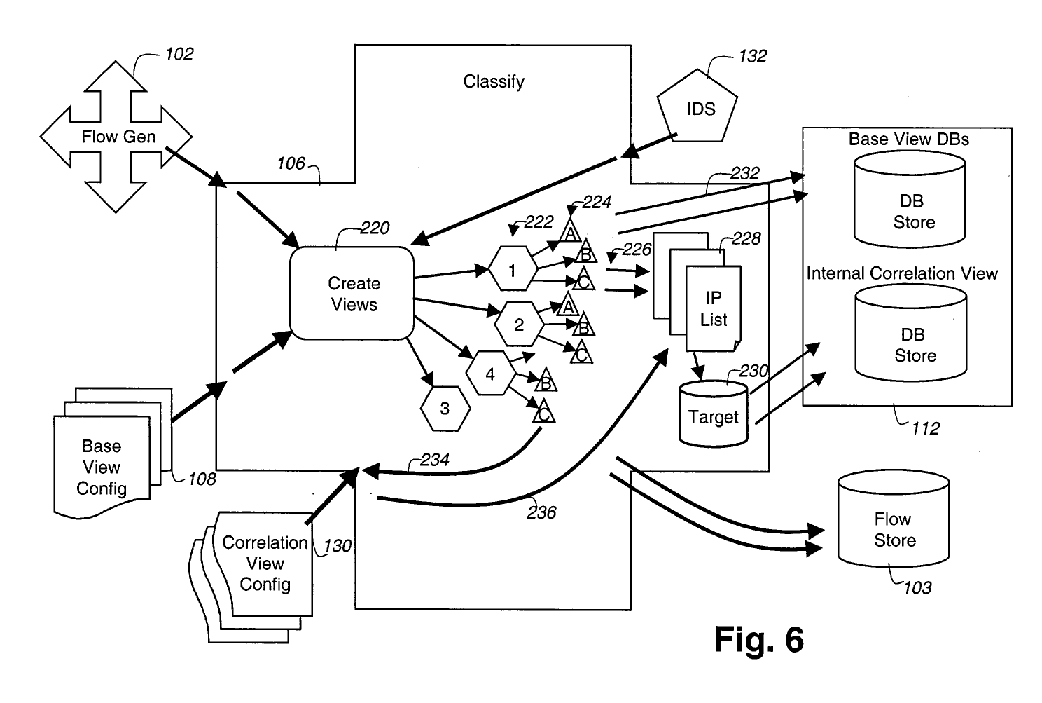

Referring to FIG. 6, there is illustrated in a functional block diagram the method of FIGS. 4 and 5 in greater detail. The method of FIG. 6 begins with classifier creating views, as represented by a block 220. The flow generator 102 provides flow records. The base configuration files 108 are used to define the views 222, which create view objects 224. View objects contain the entire aggregated information read from flows. An intrusion detection system or other device 132 provides event alerts. These are used to create external correlation views and view objects by sending 226 IP addresses to IP lists 228.

For behaviour based internal correlation, these objects are created 234 because of the configuration file graphical request language (GRL) said to combine certain objects with logical operations. For example, the internal correlation files specify that there is an object called target 230 defined by remote IPs that satisfy the following logical expression:
view 1, object A AND
view 2, objects A, B, C AND
view 4, objects A, C.
   Hence, a remote IP address must exist in all three GRLs to be added to the list for “target”.

The object definition in the configuration file for this correlation view tells us 236 that we want all traffic from this list of IP addresses put into the new object, “target” 230. Having described internal correlation and external correlation by way of examples, an additional refinement of internal correlation is now described.

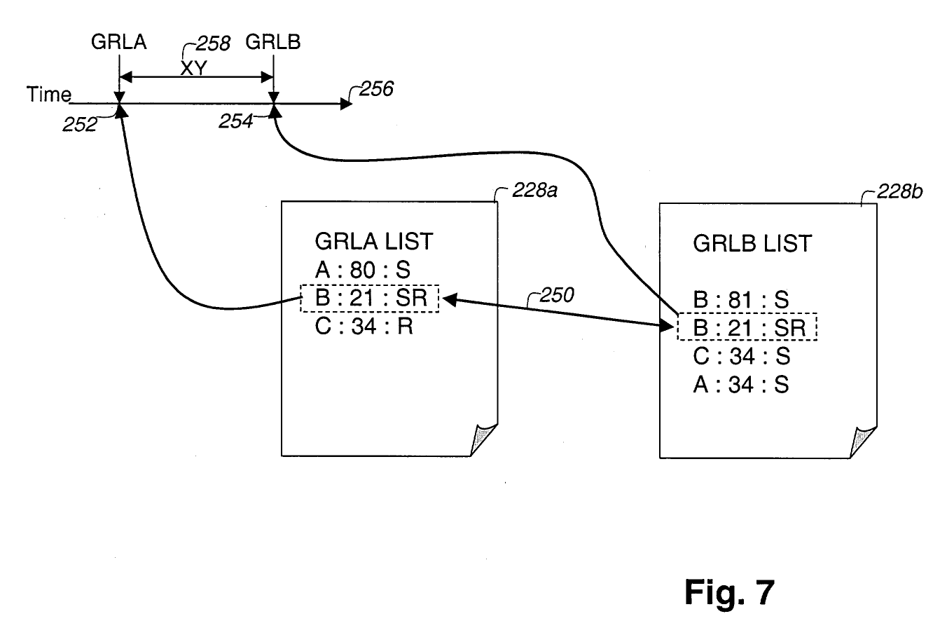

Referring to FIG. 7, there is illustrated in a block diagram a further embodiment of the present invention. FIG. 7 shows the IP lists 228 of FIG. 6 in further detail. Specifically, list for GRL A and GRL B are shown as 228a and 228b, respectively. What is entered on the lists is determined by a “tracking template” (not shown) with entries on the list being made according to specified GRLs. For example:
GRL A and GRL B=TRAP OBJECT
TRACKING TEMPLATE=REMOTE IP: PORT: FLAGS

In operation, a correlation occurs when list entries match in the list 228a and 228b, as represented by a double-headed arrow 250. Graphically, the GRL A event occurs at 252 and GRL B event occurs at 254 of time interval 256 with a time difference of XY 258 between the two events.

Thus the two events need not occur in the same arbitrary time interval. As long as the time XY 258 is within the bounds defined for the object TRAP, the match is considered valid. This facilitates catching behaviours over time.

Once the list is created in accordance with the tracking template, what is tracked can be adjusted by the use of a tracking filter. The tracking filter can specify any part of the tracking template. For example with a tracking template=REMOTE IP:PORT:FLAGS, a tracking filter=IP:PORT could be used on any traffic received after the correlation event 250. Thus, the tracking filter is used to filter traffic being placed in the TRAP bucket. The above is an example of behaviour based internal correlation. In fact all of the internal correlation described herein above is behaviour based internal correlation.

Another type of internal correlation is signature based internal correlation. Signature based internal correlation is similar to the behaviour based type described herein above, but the definitions created with logical combinations of GRLs are enforced at the flow level, that is on the flows themselves. Consequently, a logical GRL combination must match on a single flow, while a behaviour based correlation could match on a single flow, multiple flows in the same time interval or multiple flows across several intervals. Intervals are a configured section of time, e.g., Interval=30 seconds.

The following example is used to contrast signature based and behaviour based internal correlations. Let the following designations define the parameters of a correlation:
GRLA=IN only flows
GRLB=Web traffic

GRLA AND GRLB=TRAP

Signature based (Internal Correlation)

| | | | |
|---|---|---|---|
| A→B | In flow SMTP arrives | IN yes; web no | NO match |
| | One hour elapses | | |
| A→B | Out flow web arrives | IN no; web yes | NO match |
| | One hour elapses | | |
| A→B | In flow web arrives | IN yes; web yes | YES match, traffic |
| | | | placed in TRAP |

Behaviour based - Internal Correlation (2 hour event window)

| | | |
|---|---|---|
| A→B | In flow SMTP arrives | IN yes, matches GRLA, A→B, put on list |
| | One hour elapses | according to tracking template |
| A→B | Out flow web arrives | web yes, matches GRLB, A→B, put on |
| | One hour elapses | list according to tracking template |
| A→B | In flow web arrives | IN yes, matches GRLA, A→B; web yes, |
| | | matches GRLB, A→B put on both lists |
| | | according to tracking template |

Logical operation performed, A→B is result of GRLA AND GRLB, all subsequent traffic placed in ‘TRAP’

Numerous modifications, variations and adaptations may be made to the particular embodiments of the invention described above without departing from the scope of the invention, which is defined in the claims.

1. A method of correlating network activity through visualizing network data, said method comprising:
classifying network traffic in dependence upon first and second parameters into first and second network traffic views, respectively;
creating first and second view objects corresponding to the first and second network traffic views;
logically combining the first and second view objects to provide a new view object;
creating a new view corresponding to the new view object;
establishing a list of entities for the new view object; and
associating data flows for each of the entities with the new view.

2. A method as claimed in claim 1 wherein the step of establishing a list of entities uses a tracking template that defines flow data fields being stored on the list.

3. A method as claimed in claim 2 wherein the step of associating includes using a tracking filter that selects a subset of the data fields defined by the tracking template.

4. A method as claimed in claim 1 further comprising the steps of defining a network hierarchy having a plurality of points, each point representing at least one of physical, logical and functional components of a network.

5. A method as claimed in claim 4 further comprising the steps of defining conceptual views of network traffic and associating the conceptual views with each point of the network hierarchy.

6. A method as claimed in claim 5 wherein each point of the network hierarchy is represented by a graphical request language (GRL) designation.

7. A method as claimed in claim 6 wherein for each conceptual view at least one view object is instantiated.

8. A method as claimed in claim 7 wherein each view object is linked to a view object database.

9. A method as claimed in claim 8 wherein data is stored in the view object database in a plurality of layers.

10. A method as claimed in claim 9 wherein the layers include at least one of bytes, packets, hosts counts, and unique ports.

11. A method as claimed in claim 6 wherein the GRL designation includes a first part related to the network hierarchy.

12. A method as claimed in claim 11 wherein the GRL designation includes a second part related to the conceptual views.

13. A method as claimed in claim 12 wherein the step of logically combining views includes the steps of using a first GRL to designate the first view and a second GRL to designate a second view and one or more logical operators for combing the first GRL and the second GRL.

14. A method as claimed in claim 13 wherein the step of logically combining views includes the steps of using a plurality of GRL to designate a plurality of views and a plurality of logical operators for combining the plurality of GRL.

15. A method as claimed in claim 1 wherein the step of logically combining views is performed on a single flow.

16. A method as claimed in claim 1 wherein the step of logically combining views is performed on one of a single flow and multiple flows in a time interval.

17. A method as claimed in claim 1 wherein the step of logically combining views is performed on one of a single flow, multiple flows in a time interval and multiple flows occurring over multiple time intervals.

18. A method of correlating network activity through visualizing network data, said method comprising:
defining a network hierarchy having a plurality of points, each point representing at least one of physical, logical and functional components of a network;
defining conceptual views of network traffic and associating the conceptual views with each point of the network hierarchy;
defining view objects in each view;
establishing a graphical request language designation (GRL) for each conceptual view;
extending the graphical request language designation to each view object depending from each conceptual view;
selecting a view and view objects that define a network behaviour subset;
obtaining a list of addresses that are performing the network behaviour subset;
defining new view objects using one or more GRL by combining the new view objects with logical operators;
generating a new list of addresses from the GRL address lists that satisfy the logical operator functions; and
placing all current and subsequent traffic for machines listed in the new list in the new view object.

19. Machine readable media containing executable computer program instructions, which when executed by a digital processing system, performs a method comprising:
classifying network traffic in dependence upon first and second parameters into first and second network traffic views, respectively;
creating first and second view objects corresponding to the first and second network traffic views;
logically combining the first and second view objects to provide a new view object;
creating a new view corresponding to the new view object;
establishing a list of entities for the new view object; and associating data flows for each of the entities with the new view.

20. Apparatus for correlating network activity through visualizing network data comprising:
means for classifying network traffic in dependence upon first and second parameters into first and second network traffic views, respectively;
means for creating first and second view objects corresponding to the first and second network traffic views;
means for logically combining the first and second view objects to provide a new view object;
means for creating a new view corresponding to the new view object;
means for establishing a list of entities for the new view object; and
means for associating data flows for each of the entities with the new view.

21. Apparatus for correlating network activity through visualizing network data comprising:
a classifier for classifying network traffic in dependence upon first and second parameters into first and second network traffic views, respectively;
base view configuration files and a view creator for creating first and second view objects corresponding to the first and second network traffic views;
a logical combiner for providing a new view object by logically combining the first and second view objects;
correlation view configuration files for creating a new view corresponding to the new view object;
a list of entities for the new view object; and
an associator for associating data flows for each of the entities with the new view.

22. A method of correlating network activity through visualizing network data, said method comprising:
receiving flow information from a flow generator creating audit records about network traffic;
receiving a record of information from an external device indicating a reason of notification;
associating a unique identifier listed in the external record with a corresponding flow record;
tagging flows so associated;
classifying tagged flows into a network traffic view; and
creating view objects in the view corresponding to flow values.

23. A method as claimed in claim 22 wherein the unique identifier is a network address.

24. A method as claimed in claim 22 wherein the unique identifier is an IP address.

25. A method as claimed in claim 22 further comprising the step of placing aggregated values from the received flows into layers of corresponding databases of the view objects.

26. A method as claimed in claim 25 wherein the aggregated values are at least one of bytes, packets, hosts, and unique ports.
